(19) United States
(12) Patent Application Publication
(10) Pub. No.: US 2012/0002232 A1
(43) Pub. Date: Jan. 5, 2012

(54) IMAGE PROCESSING APPARATUS, DISPLAY CONTROL METHOD, AND STORAGE MEDIUM

(75) Inventor: Masanobu Inui, Chigasaki-shi (JP)

(73) Assignee: CANON KABUSHIKI KAISHA, Tokyo (JP)

(21) Appl. No.: 13/170,629

(22) Filed: Jun. 28, 2011

(30) Foreign Application Priority Data
Jul. 1, 2010 (JP) 2010-151225

(51) Int. Cl. G06K 15/02

(52) U.S. Cl. 358/1.13

(57) ABSTRACT

A display control method in an image processing apparatus to which a post-processing apparatus for performing post-processing on an output sheet is connectable includes storing, in a storage unit, image data and detailed information concerning a setting of post-processing to be set in the image data, and displaying, in a list, image data corresponding to each page stored in the storage unit, a result of output of each page, which reflects the setting of post-processing, and the detailed information of each page corresponding to the result of output.

### BACKGROUND OF THE INVENTION

1. Field of the Invention

The present invention relates to an image processing apparatus, a display control method, and a storage medium.

2. Description of the Related Art

Hitherto, image processing apparatuses such as a copying machine have memories for storing image data read by a scanner and image data received from an external device, and can accumulate image data in the memories.

Some image processing apparatuses have a preview function of displaying, when used to output image data, an output result on a user interface before outputting image data. In recent years, some image processing apparatuses have become used in print-on-demand (POD) centers, offices, and the like, which perform versatile post-processing such as bookbinding, cutting, and folding, and also perform various printing operations, such as page number printing, number-of-copies printing, and copy-forgery-inhibited pattern printing, to add, to an original, an image that doesn't exist in the original. In addition, Japanese Patent Application Laid-Open No. 2006-209398 discusses another method of displaying a preview of an output result subjected to bookbinding.

However, according to the conventional method, only a part of pages of the output result subjected to bookbinding is displayed. In addition, users cannot visually check detailed information concerning the cutting position and the binding margin of each page and the like. For example, it is difficult for users to visually grasp at what position a currently displayed page is cut, and at what position a binding margin is located.

### SUMMARY OF THE INVENTION

According to an aspect of the present invention, an image processing apparatus includes a storage unit configured to store a plurality of pages of image data and a setting of post-processing to be performed on a print product to be printed according to the plurality of pages of image data, and a display control unit configured to display, in a list, page images representing results of the post-processing performed on the print product to be printed according to the plurality of pages of image data stored in the storage unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an image processing apparatus according to an exemplary embodiment of the present invention.

FIG. 2 illustrates a hardware configuration of a controller illustrated in FIG. 1.

FIG. 3 is a perspective diagram illustrating an appearance of the image processing apparatus according to the exemplary embodiment of the present invention.

FIG. 4 is a plan diagram illustrating a configuration of an operation unit illustrated in FIG. 3.

FIGS. 5A through 5C each illustrate an operation screen displayed in a liquid crystal display unit illustrated in FIG. 4.

FIGS. 6A through 6C each illustrate a detailed example of a print data selection setting screen illustrated in FIG. 5B.

FIGS. 7A through 7I each illustrate an operation of a detailed preview screen illustrated in FIG. 5C.

FIG. 8 illustrates a detailed example of an image data display screen illustrated in FIG. 5A.

FIG. 9 is a flowchart illustrating an example of data processing performed by the image processing apparatus.

FIG. 10 illustrates image data selected in the print data selection setting screen.

FIG. 11 illustrates image data setting information managed in a disk.

FIG. 12 is a flowchart illustrating an example of data processing performed by the image processing apparatus.

FIG. 13 illustrates an example of an initial screen displayed in the operation unit illustrated in FIG. 1.

FIG. 14 is a flowchart illustrating an example of data processing performed by the image processing apparatus.

FIGS. 15A and 15B each illustrate an operation screen displayed in the liquid crystal display unit illustrated in FIG. 4.

FIGS. 16A and 16B each illustrate an operation screen displayed in the liquid crystal display unit illustrated in FIG. 4.

FIG. 17 is a flowchart illustrating an example of data processing performed by the image processing apparatus.

### DESCRIPTION OF THE EMBODIMENTS

Various exemplary embodiments, features, and aspects of the invention will be described in detail below with reference to the drawings.

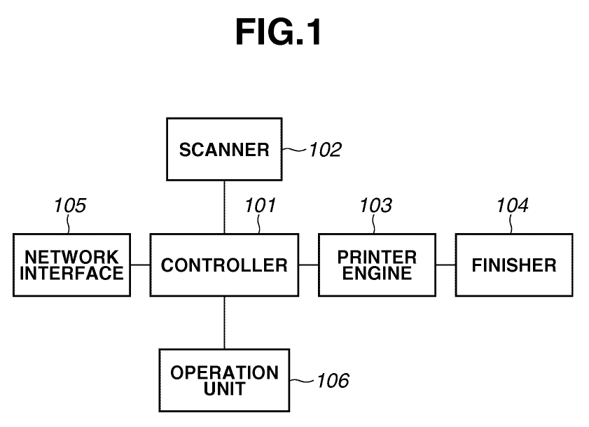

FIG. 1 is a block diagram illustrating a configuration of an image processing apparatus according to an exemplary embodiment of the present invention. In the present exemplary embodiment, a configuration of a multifunction peripheral (MFP) is described as an example of a configuration of the image processing apparatus.

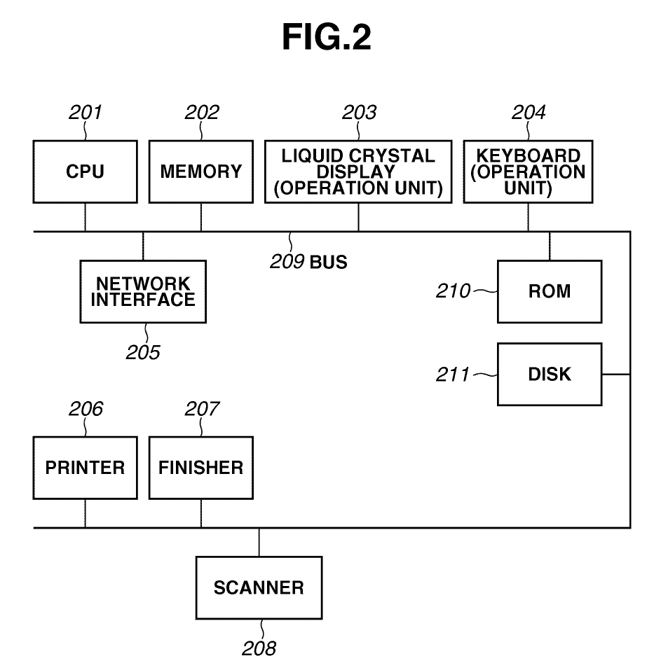

A controller 101 illustrated in FIG. 1 for controlling the MFP has a hardware configuration illustrated in FIG. 2. A scanner 102 is controlled by the controller 101. A printer engine 103 is controlled by the controller 101. This image processing apparatus is configured so that a finisher 104 can be connected to the printer engine 103. The finisher 104 functioning as a post-processing unit can perform stapling of a plurality of recording media (e.g., output sheets) output from the printer engine 103. The finisher 104 collectively performs post-processing on output sheets output from the printer engine 103. The finisher 104 is controlled through communication by the controller 101. The finisher 104 performs post-processing, the setting of which can be performed in an application mode, on output sheets that are output by printing data thereon.

A network interface (e.g., Ethernet interface) 105 provides to the controller 101 bidirectional communication performed through the interface.

An operation unit 106 is configured to include a liquid crystal display (LCD) unit and a keyboard. The operation unit 106 displays information sent from the controller 101 and transmits a user's instruction to the controller 101. The image processing apparatus is connected via the network interface 105 to a network (e.g., an Ethernet, or a transmission control protocol (TCP)/Internet protocol (IP) network). The image processing apparatus performs processing to acquire a print job from the information processing apparatus and to inform the information processing apparatus of a status of the image processing apparatus.

The controller 101 performs a preview process in a bookbinding form which is set corresponding to image data selected according to a control procedure (to be described below) for a display unit of the operation unit 106. Hereinafter, the preview process according to the present exemplary embodiment is described in detail.

FIG. 2 illustrates a hardware configuration of the controller 101 illustrated in FIG. 1.

As illustrated in FIG. 2, in the controller 101, a central processing unit (CPU) 201 is connected via a bus 209 to a memory 202, the operation unit 106 including a liquid crystal display 203 and a keyboard 204, a read-only memory 210, and a disk (storage medium) 211.

Various programs and data are stored in the disk 211 such as a hard disk and a floppy disk. The programs and the data are sequentially read to the memory when needed. Then, the read programs are executed by the CPU 201.

The disk 211 can be either detachably attached to the MFP or incorporated thereinto. The programs can be downloaded from another MFP via a network and stored in the disk 211. The memory 202 includes the following types of memories, e.g., a nonvolatile memory, such as a dynamic random access memory (DRAM), and a volatile memory such as a static random access memory (SRAM). The memory 202 can have the functions of both of such types of memories. Alternatively, the controller 101 can be configured such that the memory 202 has the function of a volatile memory while the disk 211 has the function of a nonvolatile memory.

Alternatively, the memory 202 can be a removable memory medium. The liquid crystal display 203 and the keyboard 204 configure the operation unit 106 illustrated in FIG. 1. The CPU 201 writes data to the liquid crystal display 203, so that the liquid crystal display 203 displays the data. The CPU 201 receives an instruction from a user by reading data input from the keyboard 204 or the liquid crystal display 203 configured as a touch panel.

Information input from the operation unit 106 is transferred to one of the memory 202, the disk 211, and the CPU 201 and used for various processing.

The network interface 205 is connected to the bus 209. Thus, the controller 101 is configured to be capable of communicating with an information processing apparatus (not shown). The CPU 201 communicates with the information processing apparatus via the network interface 205.

In addition, a printer 206, a finisher 207, and a scanner 208 are connected to the bus 209. The printer 206, the finisher 207, and the scanner 208 correspond to the printer engine 103, the finisher 104, and the scanner 102 illustrated in FIG. 1, respectively. The CPU 201 reads and writes data from and to the engines of these components. Thus, the CPU 201 causes the engines to perform operations, such as printing and scanning, and acquires various types of status information.

Image data can be saved in the disk 211 and the memory 202 in the controller 101 from the scanner 102 and the network interface 105.

Alternatively, image data can be captured into the controller 101 by preliminarily being stored in the removable memory 202 and then attaching the memory 202 to the controller 101.

Image data stored in the disk 211 can be moved or copied to the memory 202. According to contents of instructions input from the operation unit 106, various additional images (e.g., a numeral part representing the number of pages to be added when performing the page number printing) can be combined with image data stored in the memory 202.

Each of the printer 206, the finisher 207, and the scanner 208 can be provided as a single peripheral device on the network, instead of being provided within the MFP, and controlled by the controller 101 of the MFP.

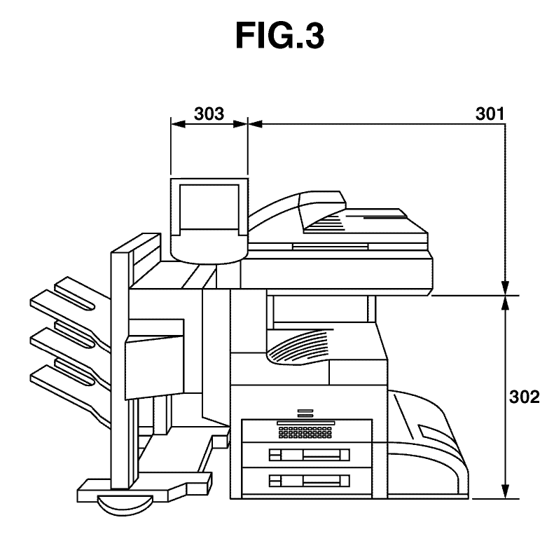

FIG. 3 is a perspective diagram illustrating an appearance of the image processing apparatus according to the present exemplary embodiment.

A scanner unit 301 serving as an image input device illustrated in FIG. 3 illuminates an image formed on paper used as an original. The scanner unit 301 causes a charge-coupled device (CCD) line sensor to scan the original. Thus, the image formed on the original placed on the scanner unit 301 is converted into electric image data.

A printer unit 302 serving an image output device converts image data into an image formed on paper, prints the image on the paper, and then outputs printed paper by causing the finisher 207 to perform folding processing such as stapling and bookbinding. The printer unit 302 starts and stops a printing operation according to instructions from the CPU 201.

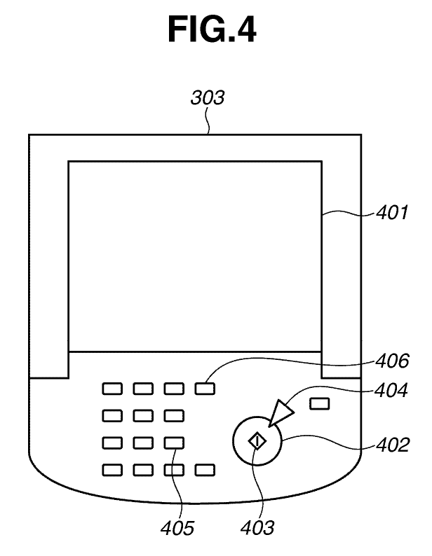

FIG. 4 is a plan diagram illustrating a configuration of the operation unit 303 illustrated in FIG. 3.

A liquid crystal display unit 401 illustrated in FIG. 4 is such that a touch panel sheet is attached onto a liquid crystal surface. The liquid crystal display unit 401 displays a system operation screen and software keys. When the displayed key is pressed, the liquid crystal display unit 401 transmits position information representing a position of the pressed key to the CPU 201.

A start key 402 is used, e.g., when an operation of reading an image of an original is started. A two-color light emitting diode (LED), i.e., a green/red LED 403 is provided at a central part of the start key 402. The color of the two-color LED 403 indicates whether the start key 402 is in a usable condition. A stop key 404 serves to stop an operation that is currently being performed.

A numeric keypad 405 is configured to include a group of numeric and character buttons. The numeric keypad 405 is used to set the number of copies and to instruct changing of a screen displayed in the liquid crystal display unit 401. A user mode key 406 is pressed when the setting of the device is performed.

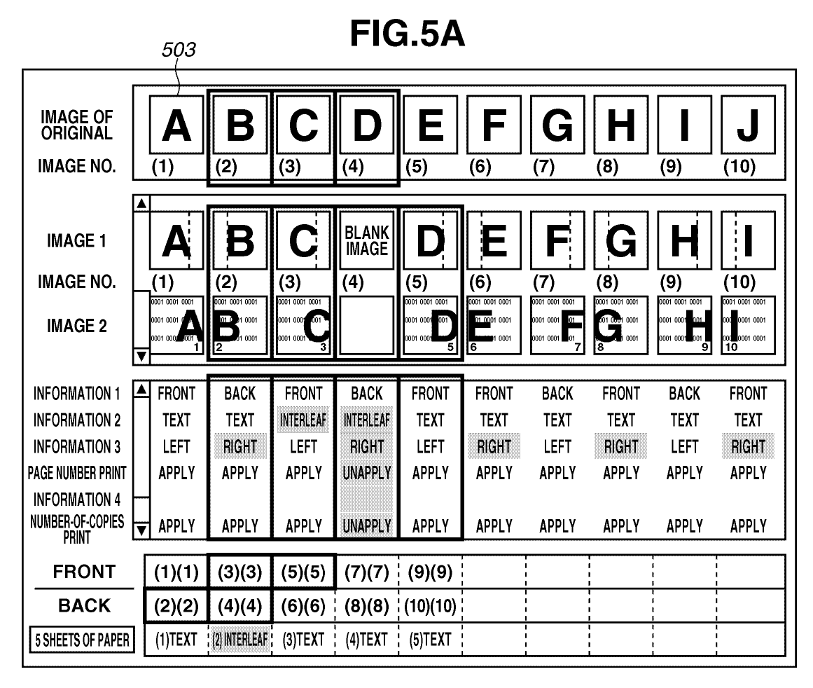

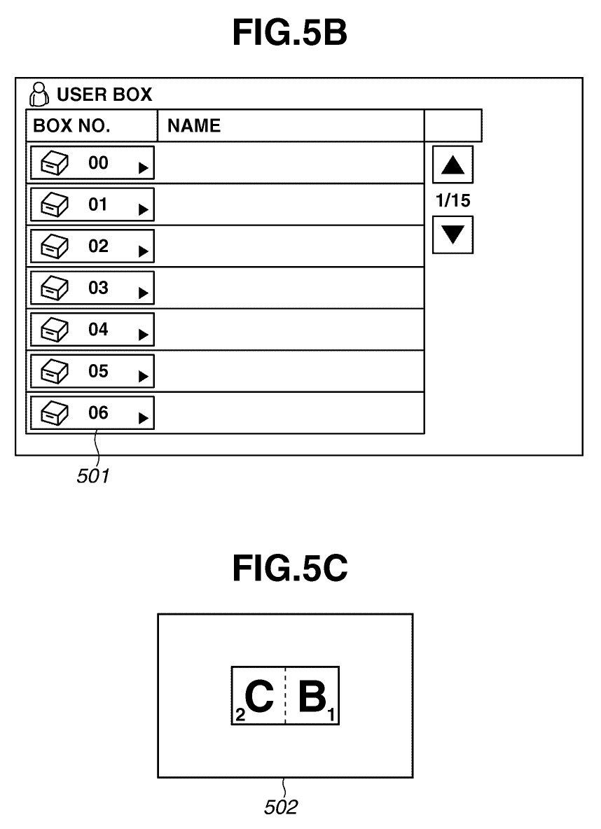

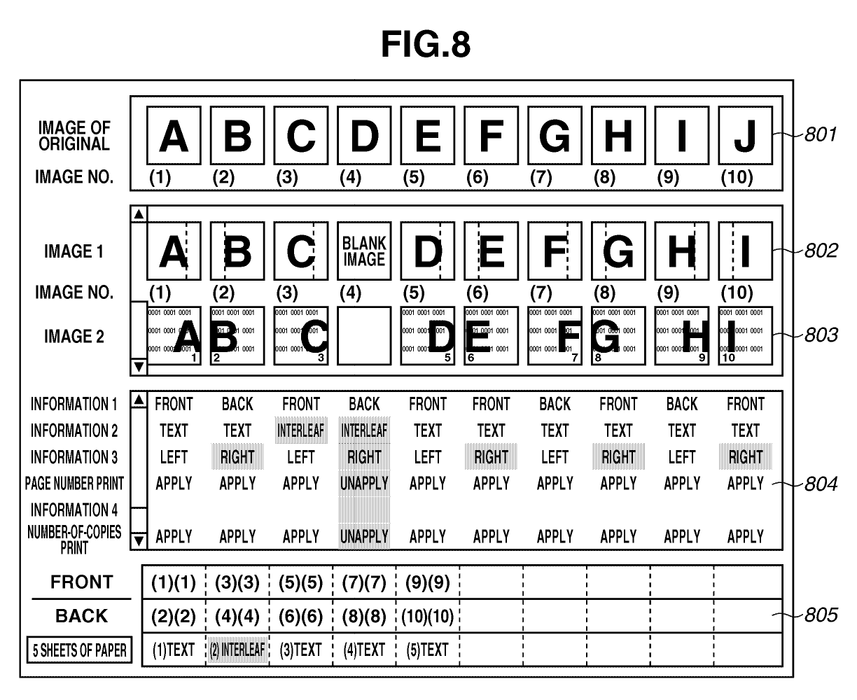

FIGS. 5A through 5C each illustrate an operation screen displayed in the liquid crystal display unit 401 illustrated in FIG. 4. Detail information concerning the post-processing is described below with reference to FIG. 8.

According to the present exemplary embodiment, the operation screen is divided into three parts. A print data selection setting screen 501 receives from a user the setting concerning which of image data stored in the disk 211 is selected, and what type printing is performed.

A detailed preview screen 502 displays an output image subjected to finishing performed by the image processing apparatus. Pages of an image represented by image data displayed on this screen can be turned in a positive (+) direction or a negative (−) direction by dragging with a finger on the touch panel.

An image data display screen 503 displays, as a list screen, individual original-image data stored in the memory 202, and image data obtained by adding contents set in the print data selection setting screen 501 to the original-image data. In addition, the image data display screen 503 displays, as a list screen, an original-image output region to be output to paper according to the set contents, and a paper layout image indicating on what parts of the paper individual images are respectively printed. The CPU 201 executes a display control operation (to be described below) to cause the liquid crystal display 203 to display the image data display screen 503.

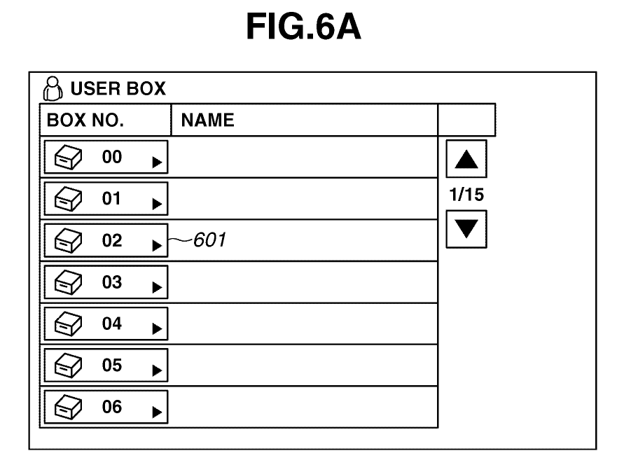

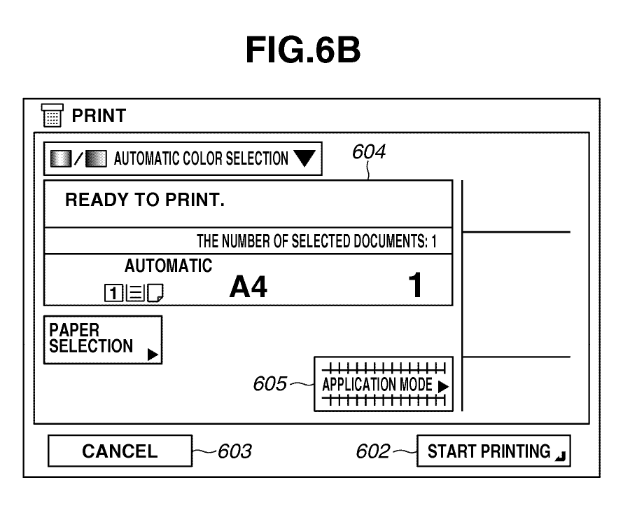

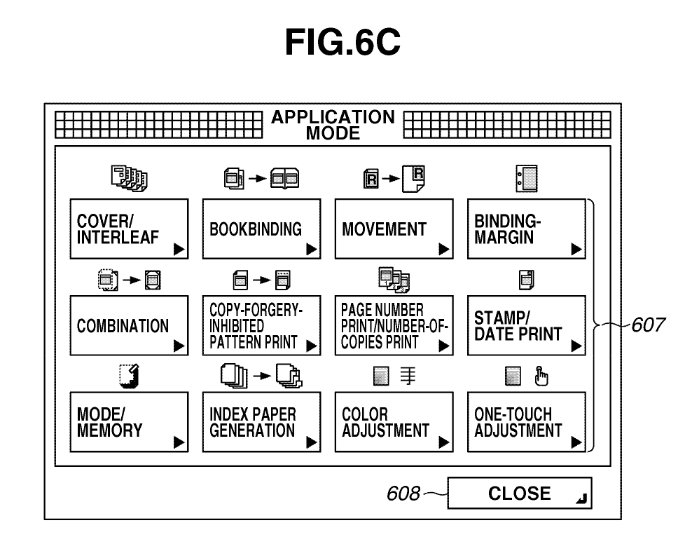

FIGS. 6A through 6C each illustrate a detailed example of the print data selection setting screen 501 illustrated in FIG. 5B. This screen is used to cause a user to select image data saved in the image processing apparatus. An example of this screen is displayed, as illustrated in FIG. 6A. A group of buttons 601 is arranged in this screen. Image data saved in the disk 211 can be selected by pressing the buttons.

When one of the buttons of the group 601 is pressed, the controller 101 copies the selected image data from the disk 211 to the memory 202, and generates output image data for editing. Then, a print setting screen illustrated in FIG. 6B is displayed under the control of the CPU 201.

In FIG. 6B, a print start button 602 is a button for starting printing. A cancel button 603 is a button for cancelling an operation on the image data selected in the screen illustrated in FIG. 6A. When the cancel button 603 is pressed, the processing is returned to the display of the screen illustrated in FIG. 6A.

A document information part 604 is a part for displaying a text size and the number of print-copies. An application mode button 605 is pressed when a detailed print mode is set.

When the application mode button 605 is pressed, an application mode setting screen illustrated in FIG. 6C is displayed in the liquid crystal display unit 401 under the control of the CPU 201.

A group of buttons 607 is arranged in the application mode setting screen illustrated in FIG. 6C. When a detailed print setting is performed, one of the buttons 607 is pressed.

In this screen, users can perform setting of information concerning the bookbinding and the binding-margin for the finisher 207. When a user performs the setting of information concerning the bookbinding and the binding-margin for the finisher 207, a process of combining an image with output image data is performed. Then, the output image data is updated and displayed.

When a close button 608 is pressed by the user upon completion of setting the application mode, the display of the screen is returned to the display of the print setting screen illustrated in FIG. 6B under the control of the CPU 201.

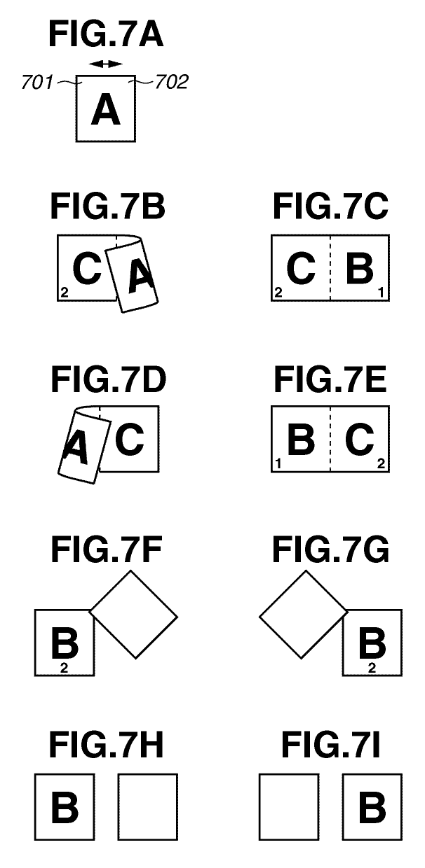

FIGS. 7A through 7I each illustrate an operation of the detailed preview screen 502 illustrated in FIG. 5C. This example is displayed when selecting image data including eight images in the screen illustrated in FIG. 6A, and performing setting of right-open saddle stitch bookbinding in the screen illustrated in FIG. 6C. When the setting is performed in the screen illustrated in FIG. 6C, the screen is changed.

After the bookbinding is set, an image corresponding to a front cover is displayed in the detailed preview screen 502, as illustrated in FIG. 7A.

When a user performs an operation (gesture operation) of dragging a part 701 in a direction of arrows with the finger on the touch panel, the CPU 201 performs a display operation of turning pages, as illustrated in FIGS. 7B and 7C.

In a state illustrated in FIG. 7C, an image corresponding to page 2 and another image corresponding to page 3 are displayed as two facing pages. Because the right-open bookbinding is set in this example, no change occurs in these images even when a part 702 is dragged with the finger.

This is because a page cannot be turned from the position of the part 702 when images of pages bookbound by the setting of the right-open bookbinding are output to paper. This display-operation is reproduced by a preview.

In the present exemplary embodiment, the CPU 201 performs a previewing operation according to the user's above operation. Thus, a user monitors images displayed in the liquid display unit 401 to thereby check whether each binding position of a print product is correct. A detailed previewing operation is described below.

FIG. 8 illustrates a detailed example of the image data display screen 503 illustrated in FIG. 5A.

Each image-of-original display part 801 is a part in which images respectively corresponding to pages represented by the selected image data are displayed. Each image-of-original output region display part 802 indicates which of regions of images represented by image data are printed on paper according to values set in the screen illustrated in FIG. 6C.

Even when a white blank-image being absent in an image represented by the image data at some set values is generated in the image-of-original output region display part 802 in the apparatus, the white image is displayed in this screen as a blank image.

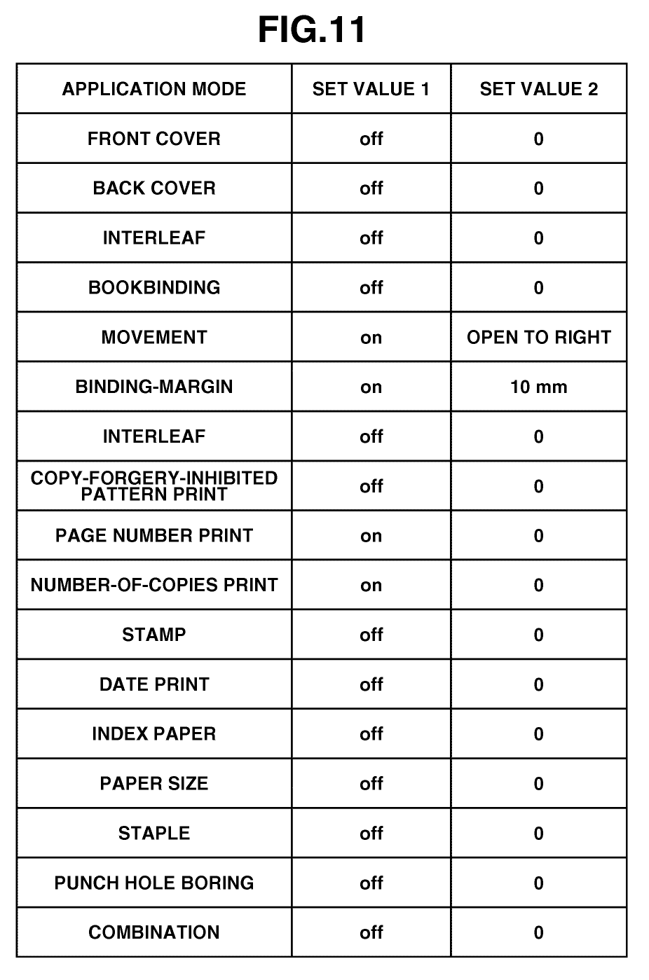

A set-content addition image display part 803 displays an image obtained by performing processing, such as page number printing and movement, on image data as an output result. The output result is adapted to reflect the setting concerning post-processing settable in the application mode. Data (i.e., the post-processing set values) representing the setting of the post-processing is stored in the disk 211 as information concerning the application mode illustrated in FIG. 11. The set values including each value whose contents specify post-processing as set-value 1 and each value representing detailed contents of an associated set-value 1 as set-value 2 are managed by being stored in the disk 211. Each of the set values is updated in response to a user's operation. Accordingly, the CPU 201 performs a control operation of updating contents of the list display of each of the screens (FIGS. 8, 15A, 15B, 16A, and 16B) in the liquid crystal display 203 according to a procedure illustrated in a flowchart (to be described below) in cooperation with the update of the set value.

A set content checking part 804 indicates whether the contents set in the screen illustrated in FIG. 6C are applied to individual pages. According to layout Nos. described in a paper layout display part 805, it can be checked how pages represented by image data are laid out on the output paper.

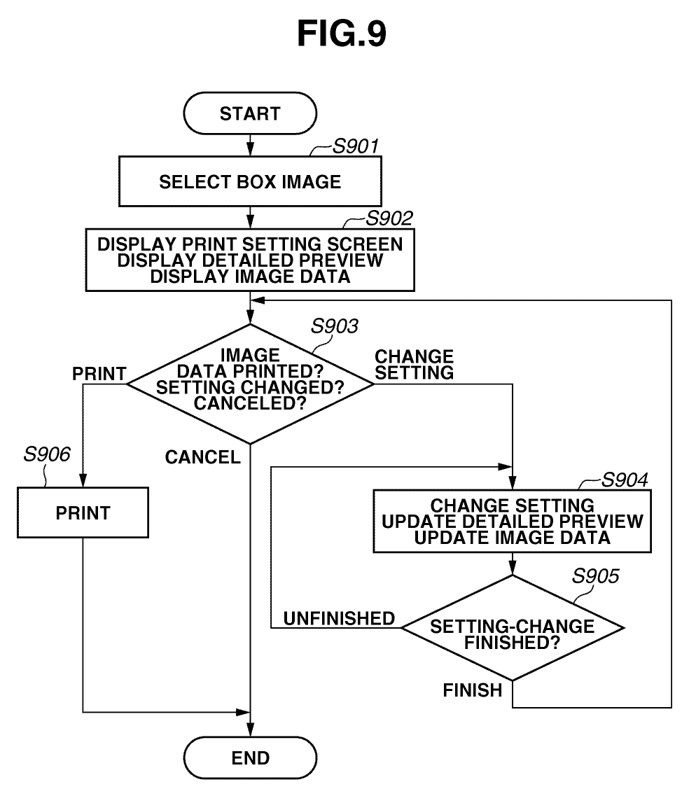

FIG. 9 is a flowchart illustrating an example of data processing performed by the image processing apparatus according to the present exemplary embodiment. Steps S901 through S906 are implemented by loading control programs stored in the ROM 210 and the disk 211 into the memory 202 and then executing the loaded control programs by the CPU 210.

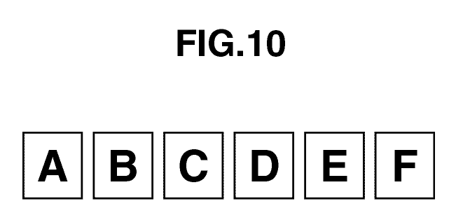

Instep S901, the CPU 201 receives from the print data selection setting screen 501 displayed in the operation unit 106 information representing selected image data to be printed. Then, the CPU 201 selects the image data stored in the disk 211. In this example, it is assumed that image data representing six images illustrated in FIG. 10 are selected.

In step S902, the CPU 201 causes the screen illustrated in FIG. 6B to be displayed. Thus, the screen for causing the CPU 201 to receive from a user an instruction for starting printing or an instruction for changing the setting of the printing is displayed in the liquid crystal display 203. At that time, the detailed preview screen 502 and the image data display screen 503 are displayed therein.

In step S903, the CPU 201 determines which of the following operations is requested. That is, one of an operation of starting printing of image data selected by a user in the screen illustrated in FIG. 6B, another operation of changing a printing method, and an operation of canceling the printing is determined by the CPU 201 as the requested operation.

If the CPU 201 determines that the user presses the print start button 602, and that the CPU 201 receives a print start instruction, then in step S906, the CPU 201 causes the printer to print the selected image data. Then, the CPU 201 ends this process.

On the other hand, if the CPU 201 determines that the user presses the cancel button 603 and that the CPU 201 receives a canceling instruction, the CPU 201 puts back the screen displayed in the operation unit 106 to the screen illustrated in FIG. 6A. Then, the CPU 201 ends this process.

On the other hand, if the CPU 201 determines that the user presses the application mode button 605 and that the CPU 201 receives a setting change instruction, the CPU 201 causes the liquid crystal display 203 of the operation unit 106 to display the screen illustrated in FIG. 6C. Then, the CPU 201 receives an instruction for changing the setting.

When receiving an instruction for changing the setting concerning the printing, the CPU 201 updates the display state of the detailed preview screen 502 and the image data display screen 503.

Every time a user changes the setting of the printing, the CPU 201 performs a display control operation for causing the liquid crystal display 203 to display a preview image reflecting always set values.

The disk 211 stores setting data having a data structure illustrated in FIG. 11. Every time the CPU 201 receives a setting change instruction from a user, the CPU 201 updates the contents of the setting data at any time.

The setting data is associated with various post-processing executable and settable in the application mode by the image processing apparatus according to the present exemplary embodiment. Accordingly, if a mode corresponding to the binding-margin is set as the application mode, a numerical value such as “XX mm” is set as a set value. If a mode corresponding to the movement is set as the application mode, information representing an opening direction, e.g., information representing open-to-right is set as the set value.

In an example illustrated in FIG. 11, data representing whether each post-processing is performed is stored as a set value 1. In addition, a numerical value or contents corresponding to the associated post-processing is stored as a set value 2.

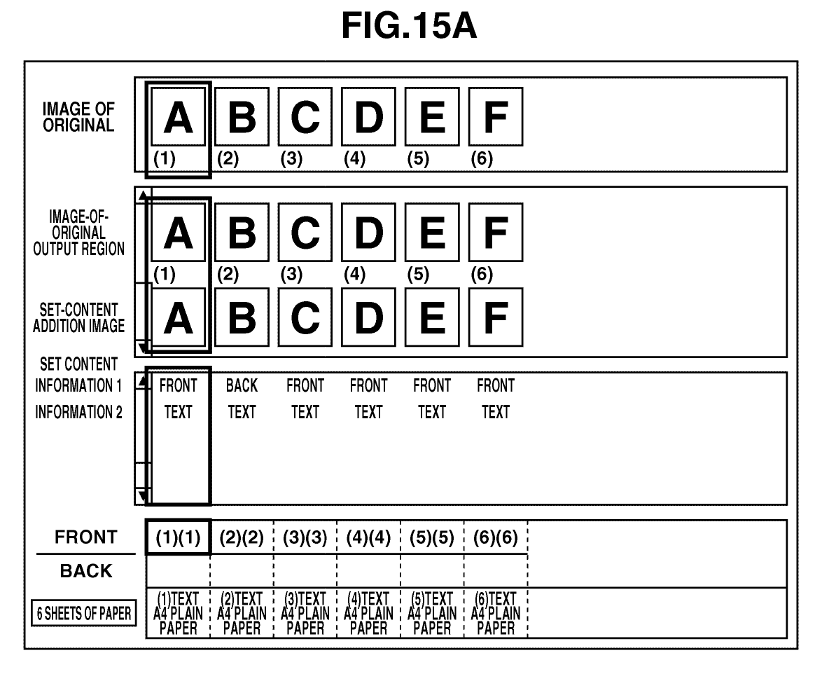

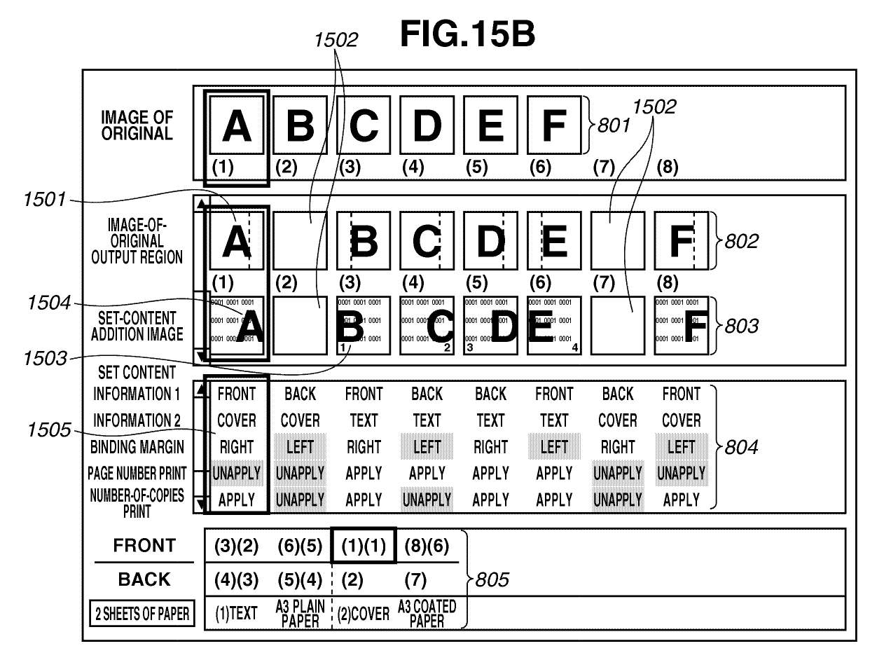

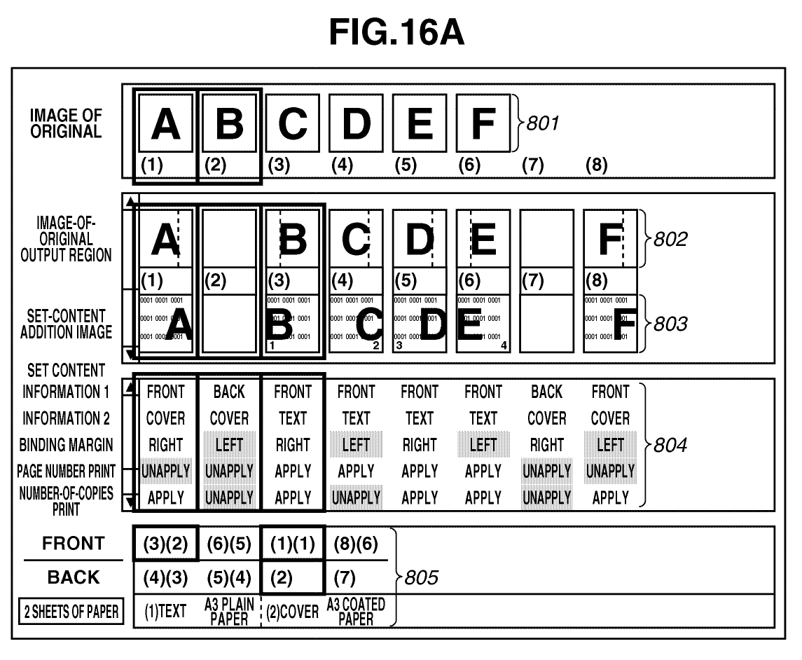

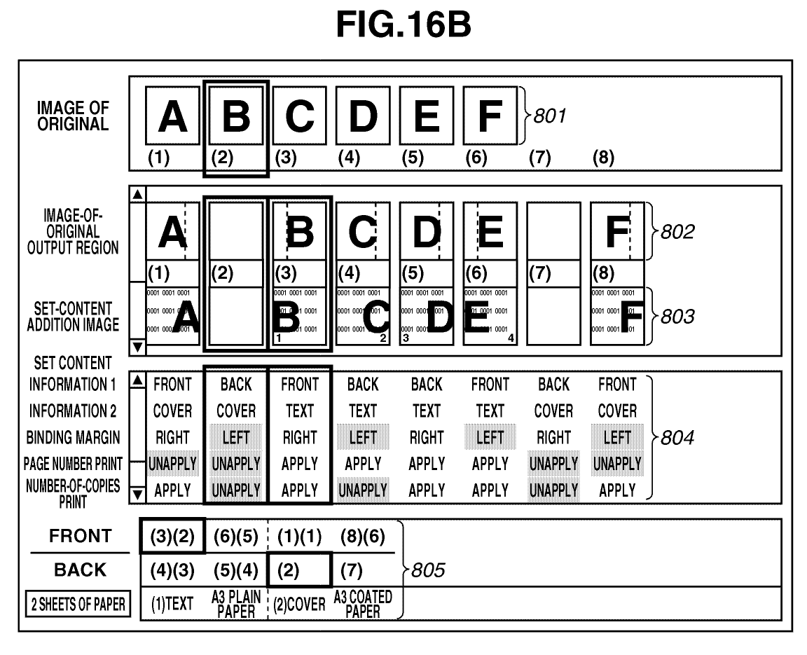

Next, in step S905, the CPU 201 determines whether the setting change is ended. If the CPU 201 determines that the setting change is not ended, then in step S904, the CPU 201 receives an instruction for the next setting change. On the other hand, if the CPU 201 determines that the setting change is ended, the CPU 201 returns to step S903. The CPU 201 executes a control operation of updating an output results corresponding to each page of the list-displays respectively illustrated in, e.g., FIGS. 15A, 15B, 16A, and 16B, and associated detail information of each page, based on the set value corresponding to the post-processing, which the CPU 201 receives in step S904. That is, the CPU 201 updates an output result of each page of the list-display and associated detail information of each page thereof at any time in cooperation with the setting change by a user. Thus, users can check, on the same screen, how the output result is changed, and the associated output result.

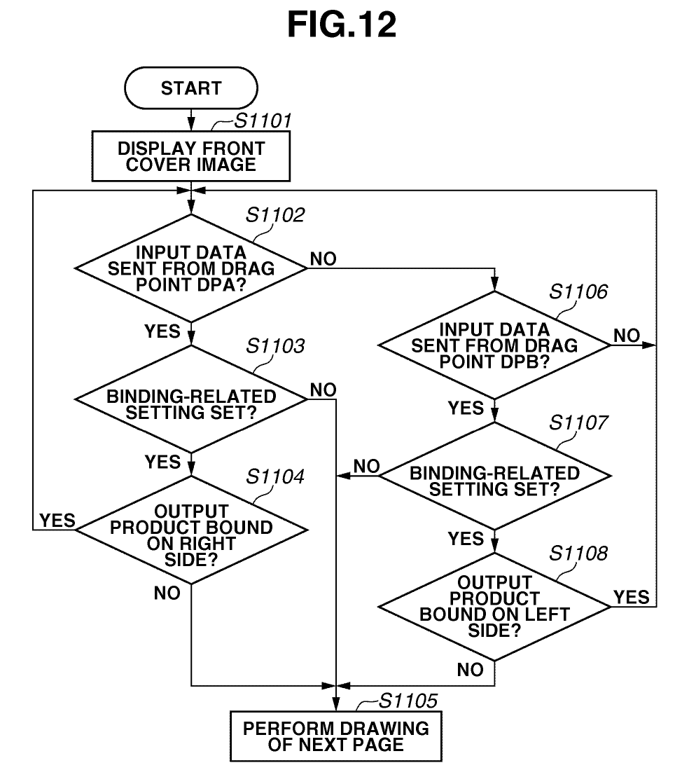

FIG. 12 is a flowchart illustrating an example of data processing performed by the image processing apparatus according to the present exemplary embodiment. This example corresponds to a detailed procedure for performing display processing of the detailed preview screen 502. Steps S1101 through 51108 can be implemented by loading into the memory 202 control programs stored in the ROM 210 and the disk 211 and executing the loaded control programs by the CPU 201.

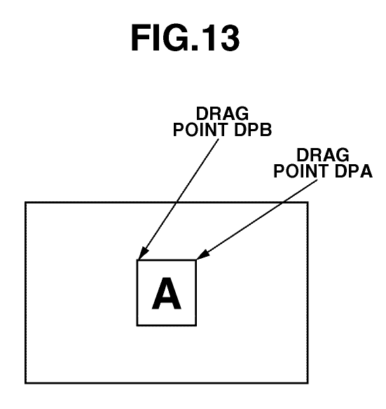

First, in step S1101, the operation unit 106 informs the CPU 201 of a notification when processing in step S902 illustrated in FIG. 9 is performed. Then, the CPU 201 causes the liquid crystal display 203 to display the detailed preview screen 502. At that time, the CPU 201 causes the liquid crystal display 203 to display image data corresponding to a leading part of an output-product output from the disk 211, as illustrated in FIG. 13.

FIG. 13 illustrates an example of an initial screen displayed in the operation unit 106 illustrated in FIG. 1.

According to the present exemplary embodiment, there are two drag points on the screen, as illustrated in FIG. 13.

The term “drag” designates an operation of moving a finger or the like while the finger or the like remains touching the screen. The term “drag point” designates a starting point at which the movement of a finger or the like is started, to be set to detect a drag operation.

First, this screen is put into an input waiting state in which the CPU 201 waits for a user's input from drag points DPA and DPB. If the CPU 201 detects that a user performs an input operation on the screen, then in step S1102, the CPU 201 determines whether the user's input is entered from the periphery of the drag point DPA.

If the CPU 201 determines that the periphery of the drag point DPA is pressed (YES in step S1102), then in step S1103, the CPU 201 searches the set data illustrated in FIG. 11 in the disk 211 illustrated in FIG. 2 for set-values for processing relating to the binding to determine whether any setting relating to the binding is performed. The “processing relating to the binding” includes processing, such as bookbinding and stapling, to bind sheets of paper at a certain point or on a certain side.

If the CPU 201 determines that no setting relating to the binding is performed (NO in step S1103), then in step S1105, the CPU 201 performs drawing for the next page.

On the other hand, if the CPU 201 determines that the presence of the setting relating to binding is confirmed (YES in step S1103), then in step S1104, the CPU 201 searches the set data illustrated in FIG. 11 in the disk 211 illustrated in FIG. 1 for the set value relating to the binding in order to determine on what part the binding is performed.

On/off information and the like set as the set value 1, and information concerning binding-position, such as open-to-right information and open-to-left information corresponding to the bookbinding, and upper-right position information and upper-left position information corresponding to the stapling set as the set value 2 are associated with the processing relating to the binding.

For example, if the CPU 201 determines that there is information indicating that binding is performed on the right side of output paper (YES in step S1104), the CPU 201 doesn't accept the dragging. Then, the CPU 201 returns to step S1102. If the CPU 201 determines that a position other than the right side of output paper is designated as the position of the binding performed thereon (NO in step S1104), the CPU 201 accepts a user's dragging instruction. Then, in step S1105, drawing of the next page is performed.

On the other hand, if the CPU 201 determines that the position designated by a user is not in the periphery of the each drag point (NO in step S1102), then in step S1106, the CPU 201 determines whether the user presses the periphery of the drag point DPB.

If the CPU 201 determines that the position designated by a user is not in the periphery of the drag point DPB (NO in step S1106), the CPU 201 returns to step S1102, in which the CPU 201 waits for a user's instruction.

On the other hand, if the CPU 201 determines that the position designated by a user is in the periphery of the drag point DPB (YES in step S1106), then in step S1107, the controller 101 searches the set data illustrated in FIG. 11 in the disk 211 illustrated in FIG. 1 for the set value for processing relating to the binding to thereby determine whether any setting relating to the binding is performed.

If the CPU 201 determines that there is no set value for processing relating to the binding (NO in step S1107), then in step S1105, the CPU 201 performs drawing for the next page.

On the other hand, if the CPU 201 determines that there is a set value for processing relating to the binding (YES in step S1107), then in step S1108, the CPU 201 searches the set data illustrated in FIG. 11 in the disk 211 illustrated in FIG. 1 for the set value to thereby determine on what part the binding is performed.

If the CPU 201 determines that the set data includes information indicating that the binding is performed on the left-side of output paper (YES in step S1108), the CPU 201 doesn't accept a user's dragging instruction. Then, the process is returned to step S1102. On the other hand, if the CPU 201 determines that a position other than the left-side of the output paper is designated (NO in step S1108), the CPU 201 accepts a user's dragging operation from the operation unit 106. In step S1105, the CPU 201 performs drawing of the next page.

If a user selects the data illustrated in FIG. 10 and sets the right-open bookbinding by causing the apparatus to perform the above operation, the CPU 201 executes the following display control operation.

In this case, a leading image corresponding to a front cover in the bookbinding is displayed as illustrated in FIG. 7A. Then, the user performs dragging to the right from the part 701 corresponding to the drag point DPB.

Consequently, the CPU 201 performs drawing of the next page on the liquid crystal display 203 in the order of steps respectively illustrated in FIGS. 7B and 7C.

Thus, if a dragging operation from the drag point DPA is performed, the CPU 201 ignores the dragging operation. Thus, users can confirm the right-open bookbinding on the operation unit 106.

If left-open bookbinding is set, the CPU 201 accepts only an operation of dragging from the drag point DPA. Thus, a user drags to the left from the part 702 corresponding to the drag point DPA. Consequently, the CPU 201 performs drawing of the next page on the liquid crystal display 203 in the order of steps respectively illustrated in FIGS. 7D and 7E. If dragging from the drag point DPB is performed, the CPU 201 ignores the dragging operation. Thus, users can confirm, on the liquid crystal display 203, the left-open bookbinding.

On the other hand, if upper-right stapling is set, the CPU 201 accepts only an operation of dragging from the drag point DPB. If dragging to the right is performed from the part 701 corresponding to the drag point DPB, the CPU 201 performs drawing as illustrated in FIG. 7F. If a dragging operation from the drag point DPA is performed, the CPU 201 ignores the dragging operation. Thus, users can confirm, on the operation unit, the upper-right stapling.

If left-upper stapling is set, the CPU 201 accepts only an operation of dragging from the drag point DPA. Thus, an operation of dragging to the left from the part 702 corresponding to the drag point DPA is performed. Consequently, the CPU 201 performs drawing as illustrated in FIG. 7G. If an operation of dragging from the drag point DPB is performed, the CPU 201 ignores the dragging operation. Thus, users can confirm, on the liquid crystal display 203, the upper-left stapling.

If setting of binding is not performed, operations from both of drag points DPA and DPB can be performed. Accordingly, if dragging to the right from the drag point DPB is performed, the CPU 201 causes the liquid crystal display 203 to display image data as illustrated in FIG. 7H.

If a dragging operation in the opposite direction is performed, the CPU 201 causes the liquid crystal display 203 to display image data as illustrated in FIG. 7I. In this case, because no setting of binding is performed, the operation can be performed from either of the drag points DPA and DPB. Users can confirm that no setting of binding is performed.

As a result of performing such an operation, a user can confirm such a fact visually and surely from a display state of the liquid crystal display 203 before it is printed whether finishing is applied to an intended place.

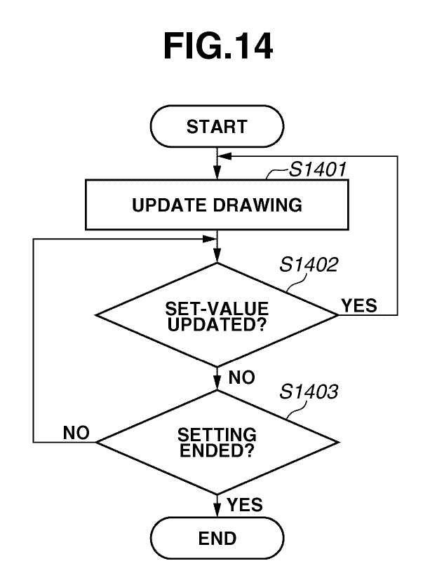

FIG. 14 is a flowchart illustrating an example of data processing performed by the image processing apparatus according to the present exemplary embodiment. This example corresponds to the detailed procedure for performing the display processing of the image data display screen 503. Steps S1401 through S1403 can be implemented by loading the control programs stored in the ROM 210 and the disk 211 into the memory 202 and executing the loaded control programs by the CPU 201.

In step S1401, the operation unit 106 informs, when processing in step S902 illustrated in FIG. 9 is performed, the CPU 201 of a notification to thereby update drawing of the image data display screen 503.

Contents of data to be displayed are displayed from a leading part of the image data. At that time, no setting is performed. Thus, the preview displaying of the same image data is performed on each of the image-of-original display part 801, the image-of-original output region display part 802, and the set-content addition image display part 803 (see FIG. 15A).

Next, after the screen is displayed in step S1401, then in step S1402, the CPU 201 determines whether the setting relating to the finisher 207 is performed by an operation in the application mode illustrated in FIG. 6C. More specifically, the CPU 201 determines whether some set-value changes among the setting data illustrated in FIG. 11 and stored in the disk 211 illustrated in FIG. 1.

If the CPU 201 determines that one of the set-values of the setting data illustrated in FIG. 11 is changed (YES in step S1402), the CPU 201 returns to step S1401 in order to update the drawing of the image data display screen 503.

On the other hand, if the CPU 201 determines that none of the set-values in the data structure illustrated in FIG. 11 are changed (NO in step S1402), then in step S1403, the CPU 301 determines whether the close button 608 is pressed (whether the setting is ended).

However, if the CPU 201 determines that the close button 608 is not pressed (NO in step S1403), the CPU 201 returns again to step S1402.

On the other hand, if the CPU 201 determines that the close button 608 is pressed (YES in step S1403), the processing illustrated in FIG. 14 is ended.

If a user performs setting of right-open bookbinding, a front cover (more specifically, only a first surface of the front cover is set to be printed), a back cover (more specifically, only a second surface of the back cover is set to be printed), page number print, number-of-copies print, and right-binding-margin in the screen illustrated in FIG. 6C as a more specific example of an operation, the drawing state of the liquid crystal display 203 is updated. Consequently, the display state of the liquid crystal display 203 is updated, as illustrated in FIG. 15B. The display state of the image-of-original display part 801 is not changed because the image-of-original display part 801 displays image data.

In the image-of-original output region display part 802, a plurality of types of setting are performed. Thus, change in the display state of the image-of-original output region display part 802 occurs.

More specifically, because the binding margin is set, the CPU 201 performs drawing to surround an output region with a frame 1501, as illustrated in FIG. 15B, such that apart output to paper can be recognized from image data.

Because the function of the “binding margin” set as the application mode is to move an image and to form a blank part serving as a binding margin on paper, sometimes, a part of image data is not printed on the paper due to the movement of an image represented by the image data. Thus, a part of input image data to be lacked, when the input image is printed, from the image data can be checked via the liquid crystal display 2003 without performing printing.

A warning display for lack of an image can be performed using a red frame, with which the output region is surrounded if such image data is lacked when the image is printed, or a black frame with which the output region is surrounded if such image data is not lacked when the image is printed.

Because a function of printing only the outside surface of the cover is set, it is necessary to output, to the inside surface of the cover, data representing a page adapted such that nothing is printed. In order to represent such a blank state, the CPU 201 displays such a page on the liquid crystal display 203 as a blank image 1502. Consequently, users can visually check in the operation unit 106 from such a display state of the liquid crystal display 2032 whether an image other than the image of an original is included in an output product.

A plurality of types of setting are performed on the set-content addition image display part 803. Thus, some change of the display state occurs. In an example illustrated in FIG. 15B, an output image 1503 is drawn, to which page number printing, number-of-copies printing, and binding-margin processing are applied. Thus, the entire image displayed in the set-content addition image display part 803 is not completely the same as that drawn based on the setting.

The page number printing is not performed on, e.g., an image represented by image data 1504, which is used as a front cover. This is because a rule that inhibits the application of the page number print to a front cover is applied to such image data.

In the screen illustrated in FIG. 15B, a set-content check part 804 indicates, corresponding to each page, whether the set application mode is applied to image data. Because the page number printing is unapplied to the covers, in an example illustrated in FIG. 15B, the CPU 201 causes the liquid crystal display 203 to indicate the term “UNAPPLY” at a page number print part 1505. In addition, because modes respectively corresponding to the binding-margin, the number-of-copies print, and the page number print, which are set as the application modes, are unapplied to blank pages, the CPU 201 causes the liquid crystal display 203 to indicate the term “UNAPPLY” at the page number print part 1505.

A paper layout display part 805 corresponds to the bookbinding. Thus, the paper layout display part 805 displays a state in which four A4-size images are arranged on both surfaces of an A3-size sheet of paper.

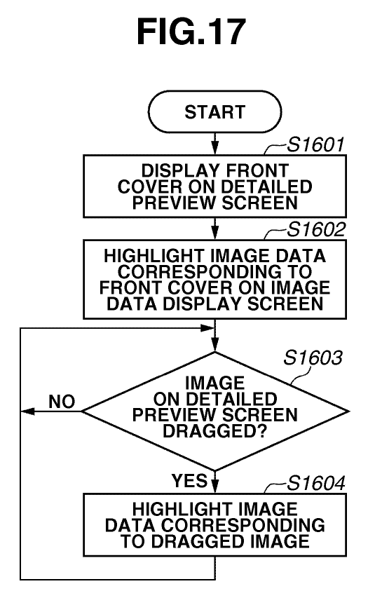

FIG. 17 is a flowchart illustrating an example of data processing performed by the image processing apparatus according to the present exemplary embodiment. This example corresponds to a detailed procedure for performing display processing of the image data display screen 503 displayed when the detailed preview screen 502 is dragged. Steps S1601 through S1604 are implemented by loading the control programs stored in the ROM 210 and the disk 211 into the memory 202 and executing the loaded control programs by the CPU 201.

First, in step S1601, the CPU 201 causes the liquid crystal display 203 to display a front cover in the detailed preview screen 502. Instep S1602, image data displayed on the image data display screen 503 corresponding to the screen displayed in the detailed preview is highlighted.

FIG. 15B indicates such a state. Because the liquid crystal display 203 displays the image data in a state in which the image data is actually emphasized with a red frame, users can visually confirm that this image data is image data representing the front cover.

Then, in step S1603, the CPU 201 determines whether a dragging operation is performed on a preview displayed in the detailed preview screen 502. If the CPU 201 determines that a dragging operation is performed on a preview displayed in the detailed preview screen 502 (YES in step S1603), then in step S1604, the image data displayed on the image data display screen 502, which corresponds to the dragged image, is highlighted.

FIG. 16A illustrates a screen in a dragged state illustrated in FIG. 7B. Image data emphasized with a red frame indicates a first page, a second page, and a third page.

FIG. 16B illustrates a screen in a state in which the dragging illustrated in FIG. 7C is ended. Image data emphasized with a red frame indicates a second page and a third page.

Thus, the dragging and the preview processing are caused to cooperate with each other. Consequently, users can visually and clearly recognize what No. of a page corresponds to a page “pinched” on the liquid crystal display 203, and what image processing is executed on the “pinched” page.

As described above, according to the exemplary embodiment of the present invention, the detailed preview screen 502 is displayed only by selecting image data to be printed. Whether the setting of the finishing is appropriately applied can be checked by dragging an image on the detailed preview screen 502.

An image on which processing corresponding to a set application mode is performed can be checked on the image data display screen 503 in cooperation with an operation of turning a page performed on the detailed preview screen 502. Consequently, whether a deficit of image data of a given page exists can be checked on paper by comparing an output state of the image from each of the image-of-original output region display part 802 and the set-content addition image display part 803 with an image of an original displayed in the image-of-original display part 801.

Users can check information concerning the set-content check part 804 of the image data display screen 503. Thus, users can easily recognize how the contents of the application mode set on the image of the set-content addition image display part 803 are reflected on a print product.

In addition, users can check the paper layout display part 805 so that the users can grasp in what part of paper a page dragged on the detailed preview screen 502 is reflected, and in what type of paper the dragged page is reflected. Consequently, users can check output results without performing trial printing thereof. Accordingly, a load on a user's operation can be reduced. Consequently, an environmental load can be alleviated by reducing print waste.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-151225 filed Jul. 1, 2010, which is hereby incorporated by reference herein in its entirety.

What is claimed is:

1. An image processing apparatus comprising:
a storage unit configured to store a plurality of pages of image data and a setting of post-processing to be performed on a print product to be printed according to the plurality of pages of image data; and
a display control unit configured to display, in a list, page images representing results of the post-processing performed on the print product to be printed according to the plurality of pages of image data stored in the storage unit.

2. The image processing apparatus according to claim 1, further comprising:
an accepting unit configured to accept an instruction for changing the setting of post-processing to be performed on the print product according to the plurality of pages of image data displayed by the display control unit,
wherein the display control unit updates display of the page images displayed in a list according to the instruction accepted by the accepting unit.

3. The image processing apparatus according to claim 1, wherein the post-processing includes bookbinding.

4. The image processing apparatus according to claim 1, wherein the display control unit is configured to further display detailed information for each page.

5. The image processing apparatus according to claim 4, wherein the detailed information includes information indicating which of first and second surfaces an associated page is, information representing whether an associated page is a cover, information representing whether page number printing is performed on an associated page, and information representing whether number-of-copies printing is performed on an associated page.

6. A display control method in an image processing apparatus to which a post-processing apparatus for performing post-processing on an output sheet is connectable, the display control method comprising:
storing, in a storage unit, image data and detailed information concerning a setting of post-processing to be set in the image data; and
displaying, in a list, image data corresponding to each page stored in the storage unit, a result of output of each page, which reflects the setting of post-processing, and the detailed information of each page corresponding to the result of output.

7. A computer-readable storage medium storing a computer program for controlling an image processing apparatus to which a post-processing apparatus for performing post-processing on an output sheet is connectable, the computer program comprising:
a code to store, in a storage unit, image data and detailed information concerning a setting of post-processing to be set in the image data; and
a code to display, in a list, image data corresponding to each page stored in the storage unit, a result of output of each page, which reflects the setting of post-processing, and the detailed information of each page corresponding to the result of output.
